(19) United States
(12) Patent Application Publication
(10) Pub. No.: US 2007/0195033 A1
(43) Pub. Date: Aug. 23, 2007

(54) Driving method for liquid crystal light modulating device

(75) Inventors: Naoyuki Hayashi, Kanagawa (JP); Takashi Kato, Kanagawa (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/707,936

(22) Filed: Feb. 20, 2007

(30) Foreign Application Priority Data
Feb. 20, 2006 (JP) 2006-042725

(51) Int. Cl. G09G 3/36

(52) U.S. Cl. 345/87

(57) ABSTRACT

A driving method for a liquid crystal light modulating device uses a liquid crystal composition that contains liquid crystals that exhibit a scattered focal conic phase state and a transparent nematic phase state depending on the applied voltage. The driving method includes a nematic phase holding operation period and a scattered state holding operation period. In the scattered state holding operation period, the modulating device is applied with a specified voltage, of which the voltage waveform is different from that of a voltage applied in a transparent nematic phase holding operation period, in a focal conic phase state to maintain the scattered focal conic phase state.

### CROSS REFERENCE TO RELATED APPLICATION

This application claims priority under 35USC 119 from Japanese Patent Application No. 2006-042725, the disclosure of which is incorporated by reference herein.

### BACKGROUND OF THE INVENTION

1. Field of the Invention

The present invention relates to a driving method for a liquid crystal light modulating device.

2. Description of the Related Art

In a driving method for a liquid crystal light modulating device, the following methods have been disclosed as methods of switching between a scattering (light shielding) state and a transparent state.

A method has been proposed in which a capsule encapsulating liquid crystals is dispersed, for example, in a polymer, and when the circuit is opened, the alignment of the liquid crystals is random, and light is reflected irregularly due to the difference in refractive index between liquid crystals and the polymer, and scattering (light shielding) occurs. When the circuit is closed, the alignment of the liquid crystals is uniform, and since the refractive index of the liquid crystals in a long axis direction and the polymer is approximately equivalent, a transparent state is achieved, and a white scattered state and a transparent state are alternated between according to voltage. This method is disclosed in “Development of chromic materials” edited by Kunihiro Ichimura, CMC Publishing (2000), pages 226 to 236.

In this method, however, to color the liquid crystal device, a dichroic dye must be dissolved in liquid crystal, but the dichroic dye may be stained by a capsule film, or the dichroic dye may tend to align along the polymer film and the response to voltage be lost, and transmittivity in a transparent state may be lowered.

International Patent Application No. 2002/093241 discloses a method operating on the same principle as the liquid crystal dimmer device by mixing uncured ultraviolet curing resin, a polymerization initiator, a liquid crystal, and a dichroic dye, and a curing the resin by irradiating with an ultraviolet ray, thereby allowing the polymer and the liquid crystal to be separated in phase to form an interface between the polymer and the liquid crystal.

In this method, however, the dye is decomposed by the ultraviolet irradiation or by the polymerization initiator, so that the colorability of the dye decline.

### BRIEF DESCRIPTION OF THE DRAWINGS

FIG. 1 is a graph showing the transmittance of a liquid crystal light modulating device over the course of time.

FIG. 2A is a schematic diagram showing the mode of a liquid crystal light modulating device when voltage is applied to hold a nematic phase.

FIG. 2B is a schematic diagram showing the mode of the liquid crystal immediately after the applied voltage has been cut off.

FIG. 2C is a schematic diagram showing the mode of the liquid crystal a certain time after the applied voltage has been cut off.

FIG. 3 is a graph showing transmittance characteristics at an absorption peak wavelength with respect to a voltage applied to a liquid crystal light modulating device.

FIG. 4 schematically illustrates an example of a pulse waveform for a liquid crystal light modulating device according to the present invention.

### SUMMARY OF THE INVENTION

A first aspect according to the present invention relates to a method of driving a liquid crystal light modulating device comprising a liquid crystal composition including liquid crystals that exhibit a scattered focal conic phase state and a transparent nematic phase state depending on an applied voltage, the composition being filled into a cell between two transparent electrodes, the driving method comprising:

implementing a nematic phase holding operation period for maintaining a nematic phase state by applying a specified voltage; and

implementing a scattered state holding operation period for applying a specified voltage, having a different voltage waveform from a voltage waveform of the voltage applied in the transparent nematic phase holding operation period, in a focal conic phase state to maintain the scattered focal conic phase state.

### DETAILED DESCRIPTION OF THE INVENTION

The present inventors acquired knowledge of a hysteresis characteristic whereby the scattered state of a focal conic phase is strong immediately after shielding of voltage applied for holding a colorless transparent state, and that the scattering becomes weak as time passes, and made further investigations based on this knowledge to eventually complete the present invention.

The driving method for a liquid crystal light modulating device according to the present invention is as follows.

[1] A method of driving a liquid crystal light modulating device comprising a liquid crystal composition including liquid crystals that exhibit a scattered focal conic phase state and a transparent nematic phase state depending on an applied voltage, the composition being filled into a cell between two transparent electrodes, the driving method comprising:

implementing a nematic phase holding operation period for maintaining a nematic phase state by applying a specified voltage; and

implementing a scattered state holding operation period for applying a specified voltage, having a different voltage waveform from a voltage waveform of the voltage applied in the transparent nematic phase holding operation period, in a focal conic phase state to maintain the scattered focal conic phase state.

Further, the driving method for a liquid crystal light modulating device according to the present invention is as follows.

[2] A method of driving a liquid crystal light modulating device comprising a liquid crystal composition including liquid crystals that exhibit a scattered focal conic phase state and a transparent nematic phase state depending on an applied voltage, the composition being filled into a cell between two transparent electrodes, the driving method comprising:

selecting any one of

(1) a first phase changing operation for changing from a scattered focal conic phase state to a nematic phase state by applying a specified voltage,

(2) a nematic phase holding operation period for maintaining the nematic phase state by applying a specified voltage,

(3) a second phase changing operation for changing from the nematic phase state to a focal conic phase state by cutting off the specified voltage, and

(4) a scattered state holding operation period for maintaining the scattered focal conic phase state by applying a specified voltage, having a different voltage waveform from a voltage waveform of the voltage applied in the transparent nematic phase holding operation period, after the second phase changing operation.

In liquid crystal exhibiting a scattered focal conic phase state and a nematic phase state, the scattered state of a focal conic phase is expressed strongly immediately after cutting off a voltage applied to hold the nematic phase state, and it is clear that the scattering becomes weaker as time passes. By making use of this characteristic, it is possible to maintain a scattered state for only a specified time, but in order to keep the scattered state constant for a long time, a specified voltage must be applied periodically.

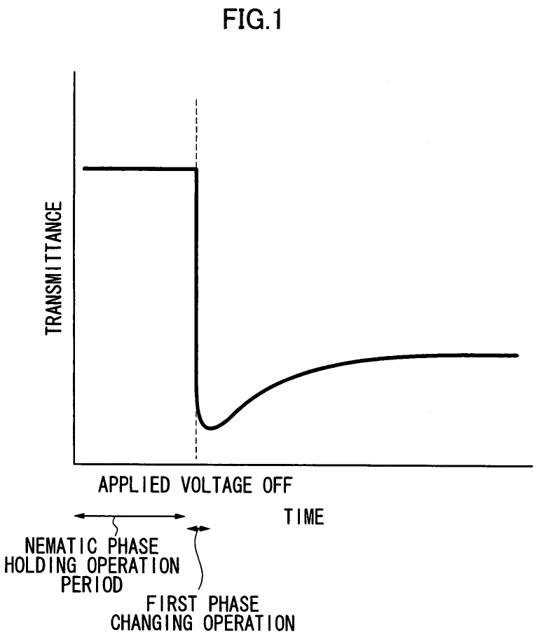

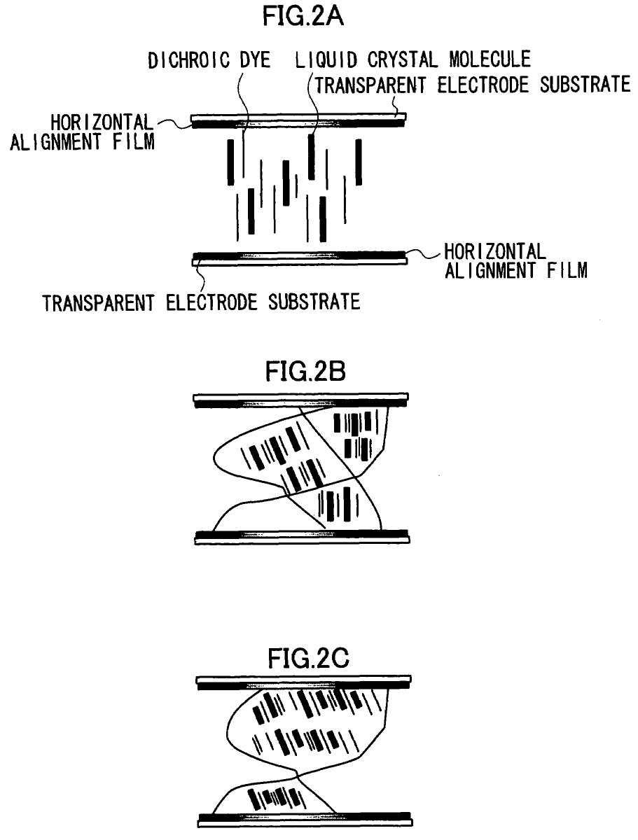

Referring to FIG. 1 and FIG. 2, the mode of the phase state of the liquid crystal is explained. In FIG. 1, the horizontal axis denotes a passage of time, and the vertical axis represents the transmittance of the liquid crystal light modulating device. In FIG. 1, voltage is applied continuously such that a nematic phase state is exhibited, and then the voltage is cut off and voltage is not applied thereafter, and changes in transmittance of the liquid crystal are shown.

As shown in FIG. 1, immediately after cutting off the applied voltage, a scattered state of the focal conic phase is strong, and transmittance is at its lowest, but as time passes, the transmittance gradually rises.

The reason for this characteristic is not known, but may be inferred as follows.

FIG. 2A is a schematic diagram showing the mode of the liquid crystal when voltage is applied to hold a nematic phase, FIG. 2B is a schematic diagram showing the mode of the liquid crystal immediately after cutting off the applied voltage, and FIG. 2C is a schematic diagram showing the mode of the liquid crystal a certain time after cutting off the applied voltage.

As shown in FIG. 2B, immediately after cutting off the applied voltage, incoherence occurs between an alignment in the vicinity of the substrate and an alignment of a cell central area, and domains are generate. In domains near the substrate, the direction of the helical axis of the focal conic phase is vertical to the substrate, but in domains in the cell central area, the direction of the helical axis of the focal conic phase is inclined with respect to the substrate. Thus, in respective domains, the direction of the helical axis of the focal conic phase is slightly misaligned, and scattering occurs at the interface of the domains, so that a scattered state occurs.

As time passes, as shown in FIG. 2C, domains join together to form larger domains, the helical axes of the focal conic phase are aligned in one direction, and it is inferred that the number of domain boundaries decreases. Therefore, immediately after cutting off the applied voltage, wherein there are many domain boundaries, the transmittance is low and the scattered state is strong, but as time passes, it is inferred that the scattered state is weakened.

In the present invention, in order to maintain the state immediately after cutting off the applied voltage, that is, in order not to lose the domain boundaries due to domains joining together, voltage is applied for a phase holding operation period for maintaining the scattered focal conic phase state. By this operation, according to the above [1], a strong scattered state can be maintained.

As mentioned above, since the scattered focal conic phase state has a characteristic of maintaining the scattering for a certain time, it is sufficient to apply the voltage at a certain time interval, rather than applying voltage continuously, to the liquid crystal in the phase holding operation period.

According to the present invention of [1] above, reduction in scattering (light shielding) over time can be prevented, and a driving method for a liquid crystal light modulating device capable of maintaining a specific light modulating performance can be provided.

According to the present invention of [2] above, reduction in scattering (light shielding) over time can be prevented by switching between the transparent state and scattered state at a given time, and a driving method for a liquid crystal light modulating device capable of maintaining a specific light modulating performance can be provided.

[3] The method of driving the liquid crystal light modulating device according to [1] or [2], wherein the voltage applied to the liquid crystal in the nematic phase holding operation period is larger than the voltage applied to the liquid crystal in the scattered state holding operation period.

Applied voltage to the liquid crystal in the nematic phase holding operation period is intended to align the liquid crystals, and must be larger than the threshold voltage. On the other hand, application of voltage to the liquid crystal in the scatter holding operation period is intended to hold the scattered focal conic phase state, and according to the inference above, it is sufficient to apply voltage to an extent capable of holding the boundaries of domains so that the domains are not joined together.

Therefore, in the scatter holding operation period, the scattered state can be held even if the applied voltage is smaller than the applied voltage in the nematic phase holding operation period, which is favorable from the perspective of saving power consumption.

[4] The method of driving the liquid crystal light modulating device according to any one of [1] to [3], wherein the liquid crystal composition contains a dichroic dye.

The above [4] of the present invention is capable of switching between colorless transparent state and colored scattered state, since the liquid crystal composition contains dichroic dye.

[5] The method of driving the liquid crystal light modulating device according to any one of [1] to [4], wherein a width of the cell is from 15 μm to 50 μm.

The above [5] of the present invention is capable of exhibiting a strong scattered state, since the scattered focal conic phase state, that is, the state which many interfaces of the domains exist is easily formed by 15 μm to 50 μm of the cell interval. Therefore, the driving method according to the above [5] is preferable for application in the liquid crystal light modulating device.

The liquid crystal light modulating device according to the present invention is as follows.

[6] A liquid crystal light modulating device comprising:

a cell formed from transparent electrodes opposing at an interval of from 15 μm to 50 μm;

a liquid crystal composition including liquid crystals that exhibit a scattered focal conic phase state and a nematic phase state depending on an applied voltage, filled into the cell; and

a control unit, which controls the applied voltage, selecting either of a nematic phase holding operation period for maintaining a nematic phase state, or a scattered state holding operation period for maintaining a scattered focal conic phase state by applying a specified voltage having a different voltage waveform from a voltage waveform of the voltage applied in the transparent nematic phase holding operation period.

[7] The liquid crystal light modulating device according to [6], wherein the liquid crystal composition contains a chiral dopant and a nematic liquid crystal.

[8] The liquid crystal light modulating device according to [7], wherein the content of the chiral dopant with respect to the total content of the liquid crystal composition is represented by the following formula:

C<n/(HTP×0.8)

wherein C represents the content of the chiral dopant, n represents the average refractive index of the liquid crystal, and HTP is an HTP value (μm⁻¹) of the chiral dopant.

[9] The liquid crystal light modulating device according to [7], wherein the content of the chiral dopant is in a range of from 2% by mass to 4% by mass with respect to the total content of the liquid crystal composition.

[10] The liquid crystal light modulating device according to [6], wherein the liquid crystal composition contains a dichroic dye.

[11] The liquid crystal light modulating device according to [10], wherein the content of the dichroic dye is in a range of from 0.1% by mass to 20% by mass with respect to the total content of the liquid crystal composition.

[12] The liquid crystal light modulating device according to [6], wherein a birefringence of the liquid crystal is in a range of from 0.1 to 0.3.

The present invention provides a driving method of the liquid crystal light modulating to be capable of preventing deteriorating performance of scattering (light shielding) according to the passage of time, and to be capable of maintaining a specific light modulating performance.

Furthermore, a driving the present invention provides a driving method of the liquid crystal light modulating to prevent deteriorating performance of transparency or coloring due to staining by a dichroic dye or being decomposed a dichroic dye.

The present invention uses liquid crystal light modulating device including a liquid crystal composition including liquid crystals that exhibit a scattered focal conic phase state and a transparent nematic phase state depending on an applied voltage, the composition being filled into a cell between two transparent electrodes. The driving method for a liquid crystal light modulating device includes implementing a nematic phase holding operation period, and implementing a scattered state holding operation period. The nematic phase holding operation period is for maintaining nematic phase state by applying a specified voltage. The scattered state holding operation period is for maintaining scattered focal conic phase state by a specified voltage. Herein, the a specified voltage in the scattered state holding operation period has different voltage waveform from a voltage waveform of the voltage applied in the transparent nematic phase holding operation period.

In order to switch between scatter state and transparent state of light modulating device, the driving method for a liquid crystal light modulating device selects any one of:

(1) a first phase changing operation for changing from a scattered focal conic phase state to a nematic phase state by applying a specified voltage,

(2) a nematic phase holding operation period for maintaining the nematic phase state by applying a specified voltage,

(3) a second phase changing operation for changing from the nematic phase state to a focal conic phase state by cutting off the specified voltage, and

(4) a scattered state holding operation period for maintaining the scattered focal conic phase state by applying a specified voltage, having a different voltage waveform from a voltage waveform of the applied voltage in the transparent nematic phase holding operation period, after the second phase changing operation.

That is, in consideration of the characteristics of the liquid crystal light modulating devices, whereby the scattered state is strong immediately after cutting off the voltage applied for holding the colorless transparent state, and the scattering becomes weak as time passes, the present invention is characterized by the periodic application of short pulse voltage during the scattered state holding operation period in order to maintain the scattered state.

Thus, the driving method for a liquid crystal light modulating device according to the present invention includes (1) a first phase changing operation, (2) a nematic phase holding operation period, (3) a second phase changing operation, and (4) a scattered state holding operation period.

### (1) First Phase Changing Operation

The first phase changing operation according to the present invention is intended to change from a scattered focal conic phase state (or scattered state) to a nematic phase state. To establish the nematic phase state, the applied voltage must be higher than the threshold voltage.

### (2) Nematic Phase Holding Operation Period

In the nematic phase holding operation period, the colorless transparent state of the liquid crystal is held. Therefore, the applied voltage in the nematic phase holding operation period is higher than the threshold voltage, under the pulse number thereof corresponding to the duration so as to maintain the colorless transparent state. This form of the voltage pulse may be either direct-current or alternating-current, and the waveform may be rectangular wave, triangular wave, sinusoidal wave, or any other arbitrary waveform, and the frequency is not restricted within a certain range.

The mode of the liquid crystal when voltage is applied is shown in FIG. 2A. In this liquid crystal, since the dielectric anisotropy (Δε) is positive, as shown in FIG. 2A, when a voltage higher than threshold voltage is applied, the liquid crystal molecules are aligned in vertical direction to electrode. According to the alignment of the liquid crystal molecules, the dichroic dye is also aligned vertically to the electrode. Therefore, light is not absorbed to be the colorless transparent state.

### (3) Second Phase Changing Operation

The second phase changing operation changes from the nematic phase state to a scattered focal conic phase state, and this is an operation for cutting off the voltage applied for holding the nematic phase. By cutting off the applied voltage, the alignment of the liquid crystal molecules is turbulent, and a scattered focal conic phase state is established. The mode of the liquid crystal at this time is shown in FIG. 2B.

Immediately after cutting off the applied voltage, incoherence occurs between the alignment in the vicinity of the substrate and an alignment of a cell central area, and domains are generated. In domains near the substrate, the direction of the helical axis of the focal conic phase is vertical to the substrate, on the other hand, in domains in the cell central area, the direction of the helical axis of the focal conic phase is inclined with respect to the substrate. Thus, in respective domains, the direction of the helical axis of the focal conic phase is slightly misaligned, and scattering occurs at the interfaces of the domains, so that a scattered state occurs. Therefore, if the liquid crystal composition does not contain a dichroic dye, the colorless transparent state is changed to a white scattered state by the second phase changing operation.

If, however, the liquid crystal composition contains a dichroic dye, the alignment of the liquid crystal molecules is turbulent, and the alignment of the dichroic dye is also turbulent, and the composition is colored. Hence, the colorless transparent state is changed to a colored scattered state by the second phase changing operation.

### (4) Scattered State Holding Operation Period

In the scattered state holding operation period, the scattered focal conic phase state formed by the second phase changing operation is maintained.

The voltage pulse to be applied for maintaining this scattered state may be either direct-current or alternating-current, and the waveform may be rectangular wave, triangular wave, sinusoidal wave, or any other arbitrary waveform, and the frequency is not restricted within a certain range. Duration of application or number of pulses to be applied is not particularly restricted. The scattered state may be maintained by applying single pulse, and it is preferably that the voltage lower than threshold voltage is applied because power consumption can be saved.

The voltage application interval is not restricted, as far as weakening of scatter is not remarkably recognized, and preferably from several minutes to several hours, by applying hysteresis characteristic of the scattered focal conic phase state. If the voltage is applied at an interval of from several minutes to several hours, the scattered state can be maintained without any strangeness for the human visual sense, since changes in transmittance of the liquid crystal light modulating device are small.

In the liquid crystal light modulating device according to the present invention, transmittance in colorless transparent state (nematic phase state) is about 4 times based on the transmittance in colored scattered state (scattered focal conic phase state) with regard to the total light, accordingly, a high contrast is exhibited.

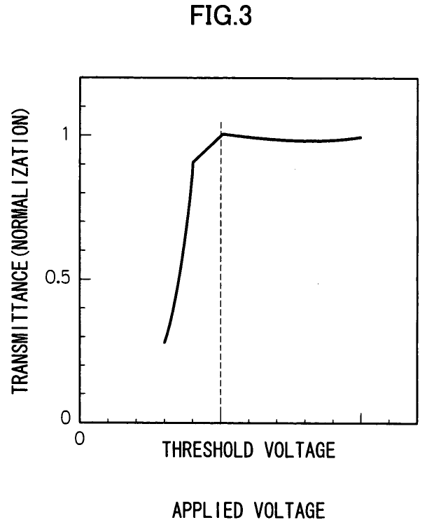

The absolute value of the applied voltage is not particularly restricted, and may be set properly depending on a concentration of the chiral dopant in the liquid crystal composition, dielectric characteristic of the liquid crystal, or distance between electrodes. FIG. 3 is a graph showing transmittance characteristics at an absorption peak wavelength with respect to a voltage applied to the liquid crystal light modulating device, and as known from this graph, the device has a voltage for starting change of transmittance (threshold voltage), and at a voltage higher than this threshold voltage, the liquid crystal molecules are aligned, and a colorless transparent state is established. The voltage to be applied in the scattered state holding operation period is a voltage to be applied for intensifying the scattered state when the scatter wanes, and if a voltage lower than threshold voltage is applied, the alignment of the liquid crystal may be turbulent, and the scattered state may be maintained, and it is preferable that the voltage lower than threshold voltage is applied, from the viewpoint of saving of power consumption.

In the present invention, the threshold voltage refers to a minimum applied voltage so that the normalization transmittance, which is normalized by saturation value of transmittance, is 1.

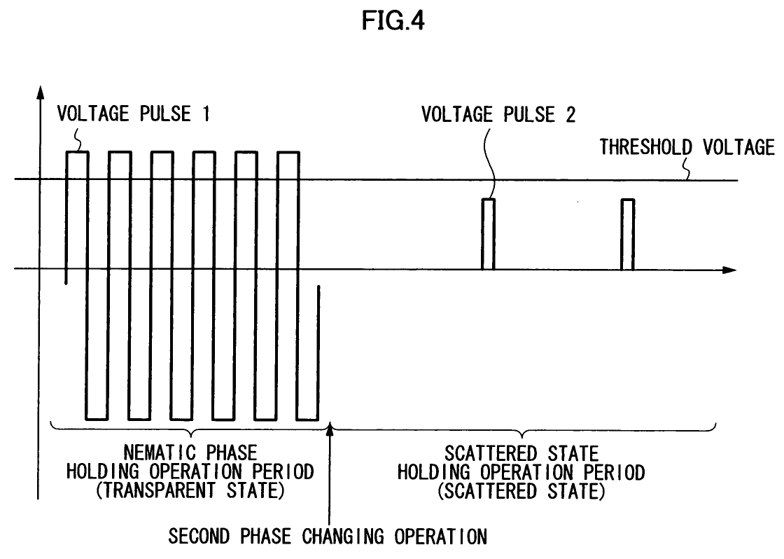

For example, FIG. 4 shows an example of pulse waveform of the voltage applied to the liquid crystal light modulating device according to the present invention, but the present invention is not limited to this example. In FIG. 4, voltage pulse applied in the nematic phase holding operation period is defined as voltage pulse 1, and the voltage pulse applied in the scattered state holding operation period is defined as voltage pulse 2.

The structure of the liquid crystal light modulating device applicable to the driving method for a liquid crystal light modulating device according to the present invention is described below.

The present invention will be described in detail below. In the present specification “ . . . to . . . ” represents a range including the numeral values represented before and after “to” as a minimum value and a maximum value, respectively.

The liquid crystal light modulating device according to the present invention is composed by filling a liquid crystal composition between a cell having two transparent electrodes. Transparent electrodes may be made of ITO or other known materials.

The interval of cells is preferred to be 15 μm to 50 μm, so that a scattered focal conic phase state may be formed easily, that is, many domain interfaces may exist, and more preferably it is 15 μm to 30 μm from the viewpoint of enhancing the degree of scattering. The cell gap can be adjusted by spacer or the like.

The space between two transparent electrodes is filled with a liquid crystal composition. The liquid crystal composition is not particularly specified, as far as nematic phase state and scattered focal conic phase state can be presented, and preferably chiral dopant is contained in a nematic liquid crystal.

As chiral dopant, for example, chiral dopants for TN and STN introduced in Liquid Crystal Handbook (edited by No. 142 Committee of the Japan Society for the Promotion of Science, published by Nikkan Kogyo Shimbun-sha, 1989, pages 199-202) may be used. Specific examples include R-1011, S-1011, R-811, S-811, and CB15 manufactured by Merck & Co.; CNL-611, CNL-617, CNL-686, CNL-687, CNL-688, CNL-689, CNL-690, CNL-691, and CNL-699 manufactured by Asahi Denka Co.; and other known products.

The content of chiral dopant is 2% by mass to 40% by mass with respect to the total content of the liquid crystal composition, and specifically the content of chiral dopant must be changed depending on the HTP (Helical Twisting Power) value exhibiting the twisting power of chiral dopant, and in order to prevent selective reflection of visible wavelength (0.8 μm or less) in colored state, the content of the chiral dopant (C) is represented by the following relation:

C<n/(HTP×0.8)

where n: the average refractive index of the liquid crystal, and HTP: an HTP value (μm⁻¹) of chiral dopant.

The host liquid crystal of the liquid crystal composition is preferably nematic liquid crystal specifically from the viewpoint of response speed. To lower the transmittance while heightening the degree of scattering of the white scattered state, it is preferred to use a host liquid crystal large in birefringence. Birefringence (Δn) preferable for host liquid crystal is about 0.1 to 0.3, or more preferably about 0.15 to 0.3.

Preferred examples of host liquid crystal include E7, E90, MLC-6621-000, and MLC-6621-100 manufactured by Merck & Co.; HA-11757C, HA-11756C, and HA-11731C manufactured by Asahi Denka Co.; and their mixtures.

The content of dichroic dye is 0.1% by mass to 20% by mass, and more preferably 1.0% by mass to 10% by mass with regard to the total content of the liquid crystal composition. When the content of dichroic dye is less than 0.1% by mass, absorption by dye may be too small, and coloring in colored state may be weak, and the contrast tends to be small, or if more than 20% by mass, (1) the viscosity of the liquid crystal is high and the response speed is slow, and (2) absorption of dye in transparent state is too large by absorption component in the direction of shorter axis of dye, and it is not preferred.

Further, in the liquid crystal composition, other known additives may be properly added, such as spherical spacer, ultraviolet absorber, and antioxidant.

In the liquid crystal light modulating device according to the present invention, aside from the transparent electrode and liquid crystal composition, support body, alignment film, ultraviolet preventive film, reflection preventive film, barrier layer, sealing agent and others may be applied.

### EXAMPLES

The present invention is further illustrated below by the following Examples. In the following Examples, the materials, reagents, substances, quantity and content thereof, or operations is replaceable, as long as being not deviated from a scope of the present invention. Hence those Examples are for illustrative explanation of the present invention, and the present invention is not limited to them.

### (Production of Device)

A liquid crystal cell was produced by using ITO substrate (100 Ω/□, manufactured by EHC Co.) formed by applying and baking horizontal alignment film SE-130 (manufactured by Nissan Chemical Co.), 20 μm of spherical spacer (SP-220, manufactured by Sekisui Chemical Co.), and epoxy type adhesive, The alignment film was not processed by rubbing.

Into E63 (manufactured by Merck & Co.) as liquid crystal compound, 3% by mass of R-1011 (manufactured by Merck & Co.) as chiral dopant, and 1.5% by mass of the following anthraquinone type dye as dichroic dye were dissolved thereto to be a liquid crystal composition. This liquid crystal composition was injected into the liquid crystal cell, and the injection port was sealed with epoxy type adhesive, and a device was produced.

The threshold value of the liquid crystal composition was 75 V. This device is transformed into colorless transparent state by application of rectangular wave of frequency of 100 Hz, and voltage of ±75 V.

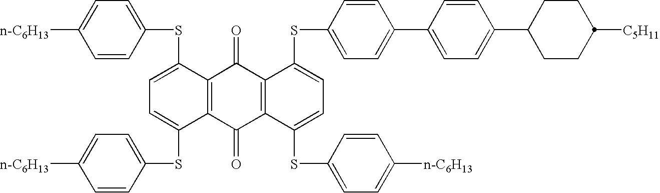

### Comparative Example 1

Rectangular wave of frequency of 100 Hz, and voltage of ±75 V was applied to the produced liquid crystal light modulating device, and a certain time later, the transmittance characteristic was measured by UV-2400 manufactured by Shimadzu Corporation. As a result, it was exhibited that the scattering was lower than one immediately after application of the voltage because the transmittance was higher.

### Example 1

Rectangular wave of frequency of 100 Hz, and voltage of ±75 V was applied to the produced liquid crystal light modulating device, and then a voltage of 75 V was applied for only 1 second at an interval of 10 minutes. As a result, it was exhibited that the scattered state was maintained and a specific transmittance characteristic was held.

### Example 2

Rectangular wave of frequency of 100 Hz, and voltage of ±75 V was applied to the produced liquid crystal light modulating device, and then a voltage of ±25 V was applied at frequency of 100 Hz for only 1 second at an interval of 10 minutes. As a result, it was exhibited that the scattered state was maintained, and a specific transmittance characteristic was held. Further, when voltage was applied for maintaining the scattering, transparent state and scattering was maintained without changing to colorless.

The foregoing description of the embodiments of the invention has been provided for the purposes of illustration and description. It is not intended to be exhaustive or to limit the present invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the present invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. A method of driving a liquid crystal light modulating device comprising a liquid crystal composition including liquid crystals that exhibit a scattered focal conic phase state and a transparent nematic phase state depending on an applied voltage, the composition being filled into a cell between two transparent electrodes, the driving method comprising:
implementing a nematic phase holding operation period for maintaining a nematic phase state by applying a specified voltage; and
implementing a scattered state holding operation period for applying a specified voltage, having a different voltage waveform from a voltage waveform of the voltage applied in the transparent nematic phase holding operation period, in a focal conic phase state to maintain the scattered focal conic phase state.

2. A method of driving a liquid crystal light modulating device comprising a liquid crystal composition including liquid crystals that exhibit a scattered focal conic phase state and a transparent nematic phase state depending on an applied voltage, the composition being filled into a cell between two transparent electrodes, the driving method comprising:
selecting any one of
(1) a first phase changing operation for changing from a scattered focal conic phase state to a nematic phase state by applying a specified voltage,
(2) a nematic phase holding operation period for maintaining the nematic phase state by applying a specified voltage,
(3) a second phase changing operation for changing from the nematic phase state to a focal conic phase state by cutting off the specified voltage, and
(4) a scattered state holding operation period for maintaining the scattered focal conic phase state by applying a specified voltage, having a different voltage waveform from a voltage waveform of the voltage applied in the transparent nematic phase holding operation period, after the second phase changing operation.

3. The driving method according to claim 1, wherein the voltage applied to the liquid crystal in the nematic phase holding operation period is larger than the voltage applied to the liquid crystal in the scattered state holding operation period.

4. The driving method according to claim 1, wherein the liquid crystal composition contains a dichroic dye.

5. The driving method according to claim 1, wherein a width of the cell is from 15 μm to 50 μm.

6. A liquid crystal light modulating device comprising:
a cell formed from transparent electrodes opposing at an interval of from 15 μm to 50 μm;
a liquid crystal composition including liquid crystals that exhibit a scattered focal conic phase state and a nematic phase state depending on an applied voltage, filled into the cell; and
a control unit, which controls the applied voltage, selecting either of a nematic phase holding operation period for maintaining a nematic phase state, or a scattered state holding operation period for maintaining a scattered focal conic phase state by applying a specified voltage having a different voltage waveform from a voltage waveform of the voltage applied in the transparent nematic phase holding operation period.

7. The liquid crystal light modulating device according to claim 6, wherein the liquid crystal composition contains a chiral dopant and a nematic liquid crystal.

8. The liquid crystal light modulating device according to claim 7, wherein the content of the chiral dopant with respect to the total content of the liquid crystal composition is represented by the following formula:
C<n/(HTP×0.8)
wherein C represents the content of the chiral dopant, n represents the average refractive index of the liquid crystal, and HTP is an HTP value (μm⁻¹) of the chiral dopant.

9. The liquid crystal light modulating device according to claim 7, wherein the content of the chiral dopant is in a range of from 2% by mass to 4% by mass with respect to the total content of the liquid crystal composition.

10. The liquid crystal light modulating device according to claim 6, wherein the liquid crystal composition contains a dichroic dye.

11. The liquid crystal light modulating device according to claim 10, wherein the content of the dichroic dye is in a range of from 0.1% by mass to 20% by mass with respect to the total content of the liquid crystal composition.

12. The liquid crystal light modulating device of claim 6, wherein a birefringence of the liquid crystal is in a range of from 0.1 to 0.3.
